(19) United States
(12) Patent Application Publication
(10) Pub. No.: US 2024/0037165 A1
(43) Pub. Date: Feb. 1, 2024

(54) IMAGE GENERATION SYSTEM, OPERATION METHOD OF IMAGE GENERATION SYSTEM, AND STORAGE MEDIUM

(71) Applicant: Canon Kabushiki Kaisha, Tokyo (JP)

(72) Inventor: KOICHI YAMAMOTO, Kanagawa (JP)

(21) Appl. No.: 18/340,144

(22) Filed: Jun. 23, 2023

(30) Foreign Application Priority Data
Jul. 26, 2022 (JP) 2022-118869

(51) Int. Cl. G06F 16/955

(52) U.S. Cl. CPC G06F 16/9566

(57) ABSTRACT

An image generation system, comprising: a determination unit configured to determine whether or not a URL received from a communication apparatus is registered in a database; and a transmission unit configured to transmit, in a case where it has been determined that the URL is registered, a URL of a Web image, which Web contents corresponding to the URL have been converted into, to the communication apparatus.

### BACKGROUND OF THE INVENTION

### Field of the Invention

The present invention relates to an image generation system, a method for operating the image generation system, and a storage medium.

### Description of the Related Art

Currently, communication apparatuses in which a Web browser (hereinafter, referred to as a browser) is provided and which can view a Web page on the browser are widely used. By displaying a Web page of an external service through a browser, a communication apparatus can interoperate with the external service.

There is a form of a browser called a cloud browser where a browser engine that generates Web page rendering results is installed on a cloud server. The browser engine handles computationally intensive processing such as analysis processing or execution processing for Web pages. By executing the browser engine on the server, the computational load of the communication apparatus is reduced.

The cloud browser converts a rendering result rendered by the browser engine into an image, which is then displayed on the communication apparatus to enable the user to view the Web page. A virtual machine on the cloud is virtually allocated various device resources required by a PC. Therefore, a browser engine running on a virtual machine can operate in the same manner as a browser engine running on PC.

However, in the case of a cloud browser, the virtual machine needs to generate a Web page rendering result, then convert the rendering result into an image and transmit the image to the communication apparatus in order to use the Web page rendering result generated by the virtual machine in the communication apparatus. In this case, since the image conversion processing takes a long time, processing may take a longer time than a normal browser before the Web page can be displayed by the communication apparatus.

In relation to this, PTL1 discloses a technique of pre-reading then caching a link destination for Web contents, then using the cached Web contents.

### PRIOR ART DOCUMENTS

### Patent Document

[PTL1] Japanese Patent Laid-Open No. 2004-280405

However, according to the technique described in PTL1, in a case where the communication apparatus cannot analyze Web contents as with a cloud browser, the time required for image conversion cannot be reduced and the time required for displaying the Web contents cannot be reduced.

### SUMMARY OF THE INVENTION

The present disclosure has been made in view of the above problems, and provides a technique for reducing the amount of time required for displaying Web contents even when a communication apparatus cannot analyze the Web contents.

According to one aspect of the present invention, there is provided an image generation system, comprising:
a determination unit configured to determine whether or not a URL received from a communication apparatus is registered in a database; and
a transmission unit configured to transmit, in a case where it has been determined that the URL is registered, a URL of a Web image, which Web contents corresponding to the URL have been converted into, to the communication apparatus.

Further features of the present invention will become apparent from the following description of exemplary embodiments (with reference to the attached drawings).

### BRIEF DESCRIPTION OF THE DRAWINGS

FIG. 1 is a view illustrating an example of a system configuration according to an embodiment.

FIG. 2 is view illustrating an example of a hardware configuration of a communication apparatus according to an embodiment.

FIG. 3 is a view illustrating an example of a software configuration of the communication apparatus according to an embodiment.

FIG. 4 is a view illustrating an example of a hardware configuration of a virtual machine and a database according to an embodiment.

FIG. 5 is a view illustrating an example of a software configuration of a virtual machine according to an embodiment.

FIG. 6 is a view illustrating an example of a software configuration of a database according to an embodiment.

FIG. 7 is a view illustrating an example of database registration information according to a first and second embodiment.

FIG. 8 is a flowchart for describing a flow of processing performed by a communication apparatus according to an embodiment.

FIG. 9 is a flowchart for describing a flow of processing that the image generation system performs according to the first embodiment.

FIG. 10 is a flowchart for describing a flow of processing that the image generation system performs according to the second embodiment.

FIG. 11 is a view illustrating an example of database registration information according to a third embodiment.

FIG. 12 is a flowchart for describing a flow of processing that the image generation system performs according to the third embodiment.

FIG. 13 is a flowchart for describing a flow of processing that the image generation system performs according to a fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the present embodiment, a communication apparatus that uses an image generation system transmits a URL to the image generation system, and downloads an image of a rendering result of a Web page from the image generation system.

### System Configuration

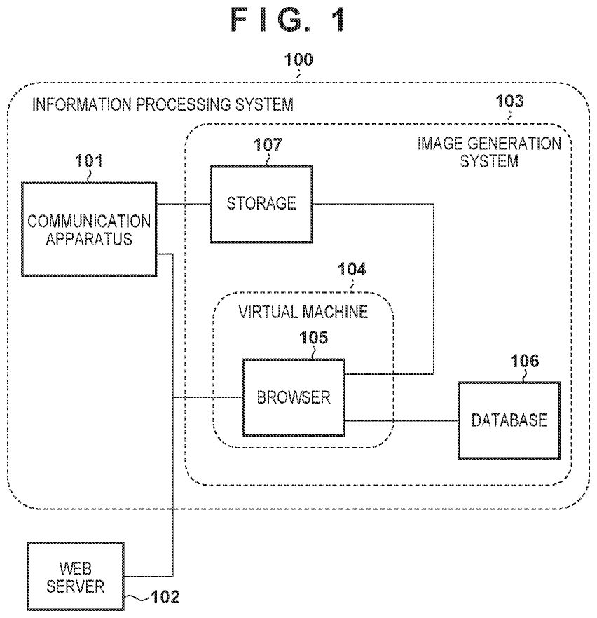

FIG. 1 is a view illustrating an example of a system configuration according to this embodiment. An information processing system 100 includes a communication apparatus 101 and an image generation system 103. A user views and operates a screen of the communication apparatus 101. The communication apparatus 101 is connected to a virtual machine 104 and a storage 107 via a network. The communication apparatus 101 requests an image generation by transmitting a URL to the virtual machine 104, and makes an image obtainment request to the storage 107. The network in the present embodiment may be, for example, the Internet, a Wide Area Network (WAN), a Local Area Network (LAN), or any combination thereof. In addition, there may be a plurality of communication apparatuses.

A Web server 102 is connected to the virtual machine 104 via a network. The Web server 102 stores Web contents. In the present embodiment, Web contents are documents described in HTML, CSS, JavaScript (registered trademark), image files such as jpeg and png, moving image files such as mp4 and webm, and the like.

The image generation system 103 includes a virtual machine 104, a database 106, and a storage 107.

The virtual machine 104 provides a browser 105. The virtual machine 104 is connected to the communication apparatus 101, the Web server 102, the database 106, and the storage 107 via a network. The virtual machine 104 receives a URL from the communication apparatus 101. Also, the virtual machine 104 obtains Web contents from the Web server 102. Further, the virtual machine 104 transmits a Web image generated by the browser 105 to the storage 107. Also, the virtual machine 104 saves data held by the virtual machine 104 to the database 106 and searches for such data therein. The browser 105 runs on the virtual machine 104, and analyzes Web contents, generates rendering results, and generates Web images. The database 106 saves information received from the virtual machine 104. The storage 107 receives and saves Web images sent from the virtual machine 104.

Note that in the illustrated example, the image generation system 103 includes the virtual machine 104, the database 106, and the storage 107, but configuration may be taken such that the database 106 and/or the storage 107 exist outside the image generation system, for example.

### Hardware Configuration of Communication Apparatus

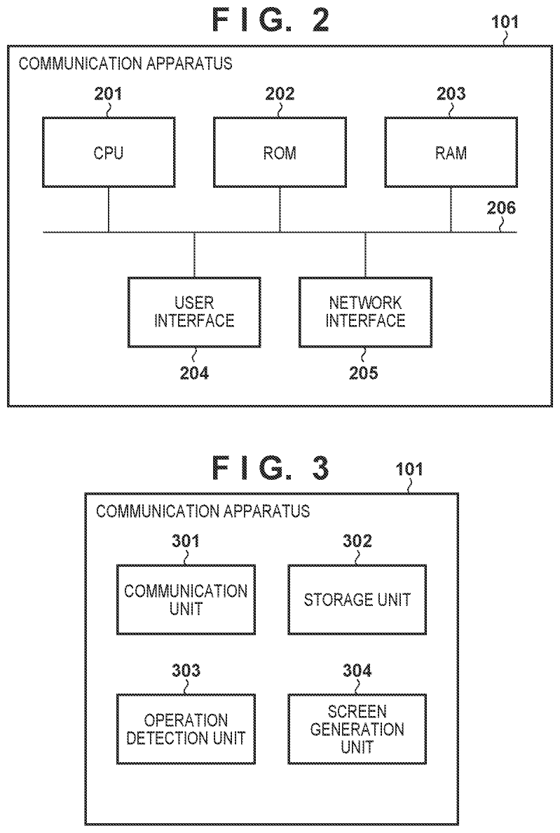

Subsequently, FIG. 2 is a view illustrating a hardware configuration of a computer apparatus constituting the communication apparatus 101 according to the present embodiment.

The communication apparatus 101 includes a CPU 201, a ROM 202, a RAM 203, a user interface 204, and a network interface 205.

The CPU 201 is a Central Processing Unit for controlling the communication apparatus 101. The ROM 202 is a Read Only Memory that stores programs and parameters that do not need to be changed. The RAM 203 is a Random Access Memory that temporarily stores programs and data supplied from an external apparatus or the like.

The user interface 204 is a screen for displaying held data and supplied data. The user interface 204 is a pointing device such as a mouse, an input device such as a keyboard, a touch panel, and the like that receives an operation from a user to input data. The network interface 205 is a network interface for connecting to a network.

A system bus 206 is a system bus that communicatively connects each constituent element from the CPU 201 to the network interface 205 together. Further, the communication apparatus 101 may include a hard disk, a memory card, or the like fixedly installed in the communication apparatus 101. Alternatively, the communication apparatus 101 may be equipped with an external storage apparatus or the like including an optical disk, such as a floppy disk (FD) or Compact Disc (CD) which is removable from the communication apparatus 101, a magnetic or optical card, an IC card, a memory card, or the like.

### Software Configuration of Communication Apparatus

Subsequently, FIG. 3 is a view illustrating a software configuration of a computer apparatus constituting the communication apparatus 101 according to the present embodiment. The communication apparatus 101 includes a communication unit 301, a storage unit 302, an operation detection unit 303, and a screen generation unit 304.

The communication unit 301 controls communication performed by the communication apparatus 101 via the network interface 205. The storage unit 302 stores Web images. The operation detection unit 303 detects contents of operations performed when the user interface 204 is operated. The screen generation unit 304 generates a screen to be displayed on the user interface 204.

### Virtual Machine and Database Hardware Configuration

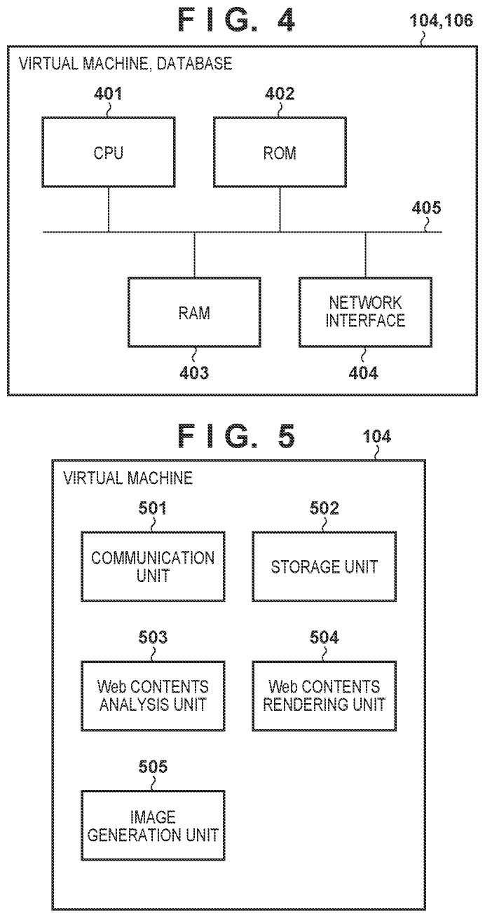

Subsequently, FIG. 4 is a view illustrating a hardware configuration of a computer apparatus constituting the virtual machine 104 and the database 106 according to the present embodiment. The virtual machine 104 and database 106 each include a CPU 401, a ROM 402, a RAM 403, and a network interface 4040.

The CPU 401 is a Central Processing Unit for controlling the virtual machine 104 and the database 106. The ROM 402 is a Read Only Memory that stores programs and parameters that do not need to be changed. The RAM 403 is a Random Access Memory that temporarily stores programs and data supplied from an external apparatus or the like. The network interface 404 is a network interface for connecting to a network. A system bus 405 is a system bus that communicatively connects each constituent element from the CPU 401 to the network interface 404 together.

### Software Configuration of Virtual Machine

FIG. 5 is a view illustrating a software configuration of the virtual machine 104 according to the present embodiment. The virtual machine 104 includes a communication unit 501, a storage unit 502, a Web contents analysis unit 503, a Web contents rendering unit 504, and an image generation unit 505.

The communication unit 501 controls communication performed by the virtual machine 104 via the network interface 404. The storage unit 502 stores Web contents and Web images. The Web contents analysis unit 503 analyzes the Web contents. The Web contents rendering unit 504 performs rendering based on the analyzed Web contents. The image generation unit 505 generates an image of a result rendered by the Web contents rendering unit 504.

### Software Configuration of Database

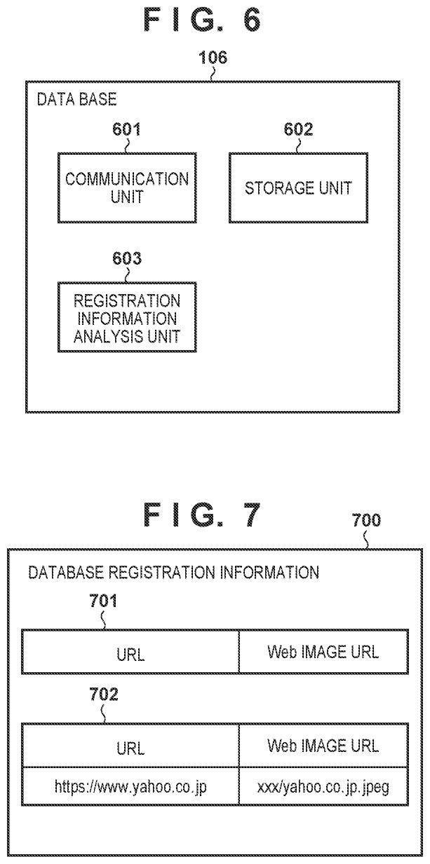

FIG. 6 is a view illustrating a software configuration of the database 106 according to the present embodiment. The database 106 includes a communication unit 601, a storage unit 602, and a registration information analysis unit 603.

The communication unit 601 controls communication performed by the database 106 via a network. The storage unit 602 stores database registration information. The registration information analysis unit 603 analyzes database registration information. Details of the database registration information will be described later with reference to FIG. 7.

### Example of Registration Information

FIG. 7 is a view illustrating an example of database registration information according to the present embodiment. Reference numerals 701 and 702 denote the state of the database registration information 700, and are stored in the storage unit 602 of the database 106. The database registration information 700 saves information of URLs and Web image URLs. URLs and Web image URLs are both information transmitted from the virtual machine 104. Also, URLs and Web image URLs are registered in association with each other. For example, in a case where the database registration information 700 is in the state of the reference numeral 702, https://www.yahoo.co.jp indicates that it is associated with xxx/yahoo.co.jp.jpeg. The “xxx” in the Web image URL is a URI, or an IP that points to a location of storage.

### Processing

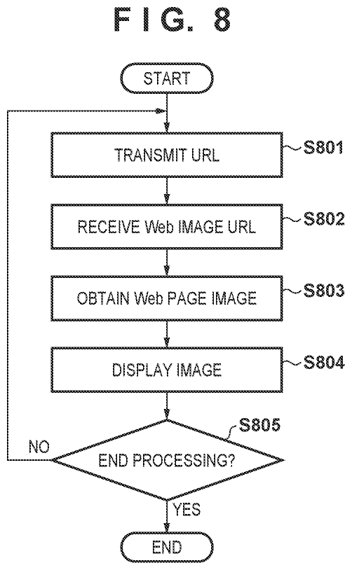

FIG. 8 is a flowchart illustrating a flow of processing performed by the communication apparatus 101 according to the present embodiment. The processing of this flowchart starts in a state where the user using the communication apparatus 101 activates an application for using the cloud browser and establishes a connection with the virtual machine 104.

In step S801, the communication unit 301 of the communication apparatus 101 transmits, to the virtual machine 104, a URL designated by a user operation detected by the operation detection unit 303. In the present embodiment, for example, https://www.yahoo.co.jp is transmitted.

In step S802, the communication unit 301 of the communication apparatus 101 receives a URL of a Web image from the virtual machine 104. In step S803, the communication unit 301 of the communication apparatus 101 obtains a Web image from the storage 107 of the image generation system 103 using the Web image URL received from the virtual machine 104. The obtained Web image is temporarily saved in the storage unit 302 of the communication apparatus 101.

In step S804, the screen generation unit 304 of the communication apparatus 101 generates and displays a screen for displaying the Web image saved in the storage unit 302 on the user interface 204 of the communication apparatus 101.

In step S805, the operation detection unit 303 of the communication apparatus 101 determines whether or not end processing has been accepted. The end processing is processing in which the user causes the cloud browser application of the communication apparatus 101 to close. In a case where the end processing is accepted (Yes in step S805), the sequence of processing ends. On the other hand, in a case where the end processing has not been accepted (No in step S805), the processing returns to step S801.

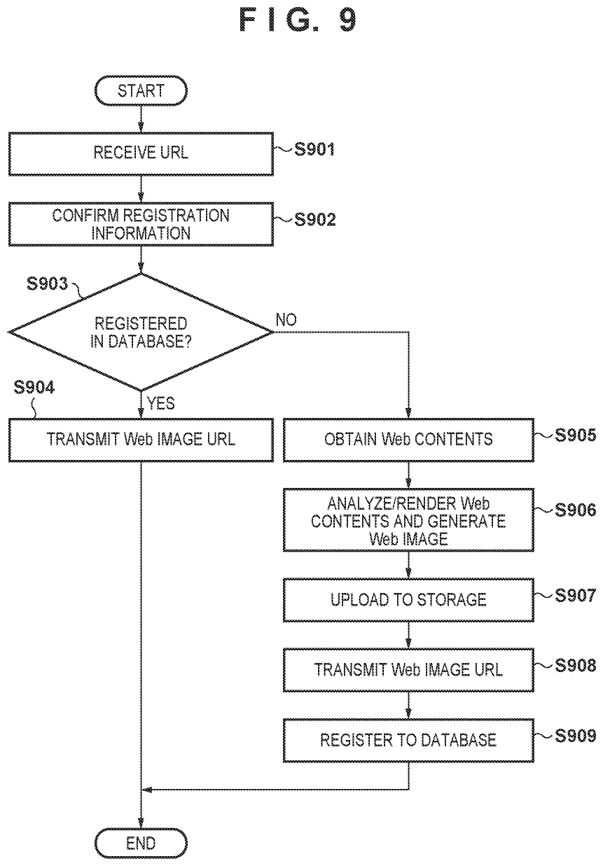

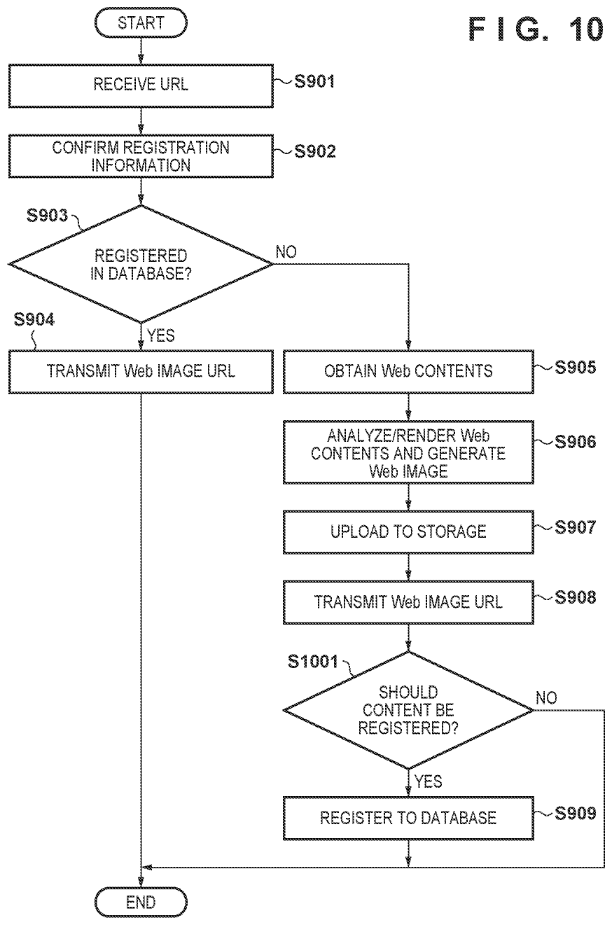

FIG. 9 is a flowchart illustrating a flow of processing performed by the image generation system 103 (mainly, the virtual machine 104 and the database 106) according to the present embodiment. The processing of this flowchart starts in a state where the user using the communication apparatus 101 activates an application for using the cloud browser and establishes a connection with the virtual machine 104.

In step S901, the communication unit 501 of the virtual machine 104 receives a URL transmitted from the communication apparatus 101. Then, the communication unit 501 of the virtual machine 104 transmits the URL received in step S901 to the database 106.

In step S902, the communication unit 601 of database 106 receives the URL transmitted from the virtual machine 104. Then, the registration information analysis unit 603 of the database 106 confirms whether a URL corresponding to the received URL is registered in the database registration information 700.

In step S903, the registration information analysis unit 603 of the database 106 determines whether or not a URL corresponding to the received URL is registered in the database registration information 700. In a case where the received URL is registered in the database (Yes in step S903), the communication unit 601 of the database 106 transmits a Web image URL corresponding to the registered URL to the virtual machine 104. For example, in a case where the state of the database registration information 700 is the reference numeral 702 and the URL received in step S901 is https://www.yahoo.co.jp, the Web image URL is xxx/yahoo.co.jp.jpeg. Then, the processing advances to step S904. On the other hand, in a case where the received URL is not registered in the database (No in step S903), the communication unit 601 of the database 106 transmits a message indicating that an image is not registered to the virtual machine 104. Then, the processing advances to step S905.

In step S904, the communication unit 501 of the virtual machine 104 transmits the Web image URL obtained in step S903 to the communication apparatus 101.

In step S905, the communication unit 501 of the virtual machine 104 obtains Web contents from the Web server 102. At this time, the URL of the request to the Web server 102 for obtaining the Web contents is the URL received in step S901.

In step S906, the Web contents analysis unit 503 of the virtual machine 104 analyzes the Web contents obtained in step S905, and then the Web contents rendering unit 504 of the virtual machine 104 renders the Web contents. Thereafter, the image generation unit 505 generates the Web image based on the rendered Web contents. The generated image is, for example, an image file such as a jpeg or a png.

In step S907, the communication unit 501 of the virtual machine 104 uploads the image generated in step S906 to the storage 107. In step S908, the communication unit 501 of the virtual machine 104 transmits the URL of the upload destination uploaded in step S907 to the communication apparatus 101.

In step S909, the communication unit 501 of the virtual machine 104 transmits the URL received in step S901 and the URL of the destination to which the image has been uploaded in step S907 to the database 106. After receiving the information from the virtual machine 104, the communication unit 601 of the database 106 registers the information in the database registration information 700. For example, the state of the database registration information 700 is the reference numeral 701, and the information received is URL=https://www.yahoo.co.jp and URL of the upload destination=xxx/yahoo.co.jp.jpeg. In this case, the database registration information 700 becomes the state of the reference numeral 702. The above described sequence of processing in FIG. 9 then ends.

As described above, according to the present embodiment, in a case where a URL transmitted by the communication apparatus 101 is registered in the database 106, the communication apparatus 101 can obtain a Web image from the storage 107 without waiting for processing for Web image generation of the virtual machine 104.

Note that the processing for Web image generation refers to processing of obtaining Web contents, processing of generating a Web image, and processing of uploading the Web image to the storage 107.

Accordingly, it is possible to shorten the time from when the communication apparatus 101 transmits a URL to the virtual machine 104 until when a Web image is obtained, and it is possible to reduce the time required for displaying Web contents in the communication apparatus 101.

### Second Embodiment

In the present embodiment, in addition to the processing of the first embodiment, an example in which the virtual machine 104 determines the content of Web contents and determines whether or not to register the information in the database 106 prior to registering the information in the database 106 is described.

The configuration of the system and the hardware configuration and software configuration of the communication apparatus 101 in the present embodiment are similar to those shown in FIGS. 1 to 3, respectively. Also, the hardware configuration and the software configuration of the virtual machine 104 are similar to those in FIGS. 4 and 5, respectively. Further, the hardware configuration and the software configuration of the database 106 are similar to those in FIGS. 4 and 6, respectively. Additionally, the flow of the processing performed by the communication apparatus 101 according to the present embodiment is similar to the processing of FIG. 8. An example of the database registration information stored in the database 106 is similar to the database registration information illustrated in FIG. 7.

### Processing

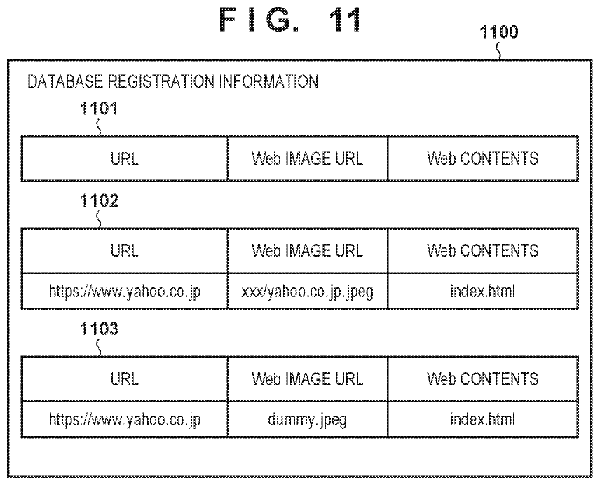

FIG. 10 is a flowchart illustrating a flow of processing performed by the image generation system 103 (mainly, the virtual machine 104 and the database 106) according to the present embodiment. The processing of this flowchart starts in a state where the user using the communication apparatus 101 activates an application for using the cloud browser and establishes a connection with the virtual machine 104. Since step S901 to step S909 of FIG. 10 are the same processing as step S901 to step S909 of FIG. 9, description thereof will be omitted.

In step S1001, the Web contents analysis unit 503 of the virtual machine 104 analyzes the contents obtained in step S905, and based on the analysis result, determines whether or not the contents are Web contents that should be registered in the database 106.

In the analysis, it is determined whether cookie information is obtained in the Web contents or whether there is an element related to a login, for example. In the case of cookie information, a determination is made based on whether or not the description of variable=document.cookie exists in the html. A determination is made based on whether or not a description of $.cookie( ) exists in JavaScript (registered trademark). Meanwhile, in the case of an element related to login, a determination is made based on whether or not a description of is_authenticated, httpServletRequest, or authentication. exists in html.

An example of a Web image that should not be registered is an image that is generated according to Web contents that are rendered depending on the user and whose contents therefor differ. For example, an image generated by a cookie from Web contents in which an ID or a password may be inputted in an input form is a Web image that should not be registered. Further, an image generated from Web contents in which a user name, a user's password, or the like are displayed as login information is a Web image that should not be registered. Therefore, in a case where a cookie is obtained in the Web contents, it is determined that the content should not be registered. In addition, in a case where there is an element related to a login, it is determined that the content should not be registered. Either or both of these may be determined.

In a case where it is determined that the content should be registered (Yes in step S1001), the processing advances to step S909. On the other hand, in a case where it is determined that the content should not be registered (No in step S1001), the processing ends.

As described above, according to the present embodiment, whether or not Web contents are registered in the database 106 can be determined based on the content of the Web contents. Accordingly, it is possible to prevent a Web image that should not be registered in the database 106 from being registered.

By not registering a Web image that should not be registered in the database 106, it is possible to prevent other users from obtaining and displaying in step S904 a Web image, generated by a certain user, that should not be registered.

Further, as a method of determining whether or not the content is to be registered, a cache control may be used. For example, in a case where the cache control is “no-cache”, it is determined that the content should not be registered (No in step S1001), and registration in the database 106 is not performed. Accordingly, it is possible to determine whether or not the content should be registered in the database 106 from the cache control of Web contents.

### Third Embodiment

In the present embodiment, in addition to the processing of the first embodiment, the virtual machine 104 registers Web contents obtained from the Web server 102 in the database 106. Further, the virtual machine 104 compares Web contents registered in the database 106 with Web contents obtained from the Web server 102, and performs processing for determining whether or not to register the information in the database 106.

The configuration of the system and the hardware configuration and software configuration of the communication apparatus 101 in the present embodiment are similar to those shown in FIGS. 1 to 3, respectively. Also, the hardware configuration and the software configuration of the virtual machine 104 are similar to those in FIGS. 4 and 5, respectively. Further, the hardware configuration and the software configuration of the database 106 are similar to those in FIGS. 4 and 6, respectively. Additionally, the flow of the processing performed by the communication apparatus 101 according to the present embodiment is similar to the processing of FIG. 8.

### Example of Registration Information

FIG. 11 is a view illustrating an example of database registration information according to the present embodiment. Reference numerals 1101 to 1103 denote the state of the database registration information 1100, and are stored in the storage unit 602 of the database 106. The database registration information 1100 saves information of a URL, a Web image URL, and Web contents. The URL, the Web image URL, and the Web contents are all information received from the virtual machine 104, and the URL, the Web image URL, and the Web contents are registered in association with each other.

For example, when the database registration information 1100 is in the state of the reference numeral 1102, it indicates that https://www.yahoo.co.jp is associated with xxx/yahoo.co.jp.jpeg and index.html. “xxx” of a Web image URL is a URI, or an IP that points to a location of storage.

### Processing

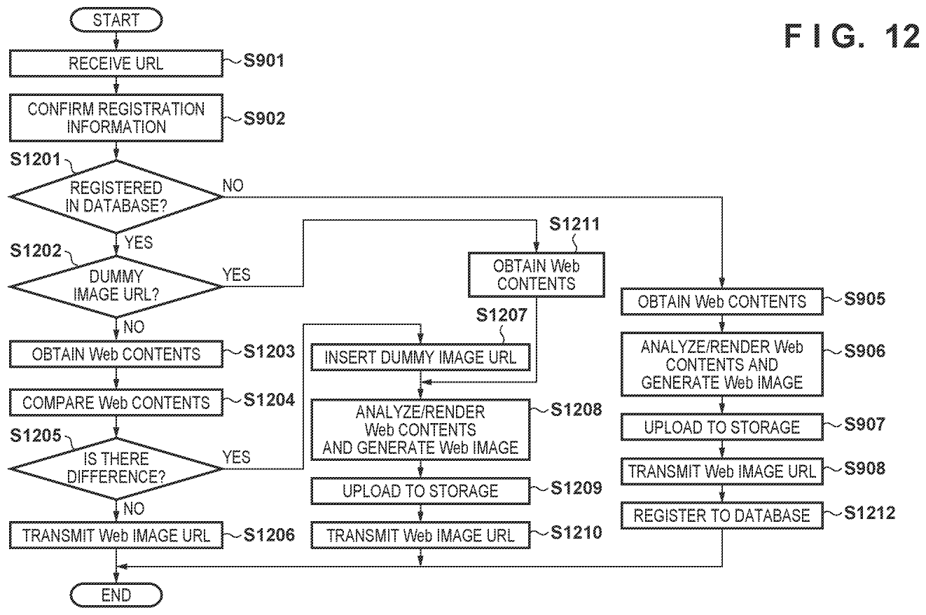

FIG. 12 is a flowchart illustrating a flow of processing performed by the image generation system 103 (mainly, the virtual machine 104 and the database 106) according to the present embodiment. The processing of this flowchart starts in a state where the user using the communication apparatus 101 activates an application for using the cloud browser and establishes a connection with the virtual machine 104. The processing of step S901, step S902, and step S905 to step S908 of FIG. 12 is the same as the processing of step S901, step S902, and step S905 to step S908 of FIG. 9, and description thereof will be omitted.

In step S1201, the registration information analysis unit 603 of the database 106 determines whether or not a Web image URL is registered in the database registration information 1100. More specifically, after the communication unit 601 of the database 106 receives the URL from the virtual machine 104, the registration information analysis unit 603 analyzes whether or not a URL corresponding to the received URL is registered. Then, as a result of the analysis, the URL is registered in the database (Yes in step S1201) and the communication unit 601 of the database 106 transmits a Web image URL corresponding to the registered URL to the virtual machine 104. Then, the processing advances to step S1202. On the other hand, in a case where the URL is not registered in the database (No in step S1201), the communication unit 601 of the database 106 transmits a message indicating that a Web image URL is not registered to the virtual machine 104. Then, the processing advances to step S905.

In step S1202, the communication unit 501 of the virtual machine 104 determines whether or not the Web image URL received from the communication unit 601 of the database 106 is a dummy image URL. Here, the dummy image URL is identification information indicating that there is a difference in the Web contents of the URL (for example, in a case where the Web contents have changed between the previous access and the current access). In a case where it is not a dummy image URL (No in step S1202), the processing advances to step S1203. On the other hand, in a case where it is a dummy image URL (Yes in step S1202), the processing advances to step S1211.

In step S1203, the communication unit 501 of the virtual machine 104 obtains the Web contents from the Web server 102. At this time, the URL of the request to the Web server 102 is the URL received in step S901. Thereafter, the communication unit 501 of the virtual machine 104 receives Web contents corresponding to the URL received in step S901 from the database registration information 1100. For example, in a case where the state of the database registration information 1100 is the reference numeral 1102 and the URL received in step S901 is https://www.yahoo.co.jp, the Web contents of index.html are received.

In step S1204, the Web contents analysis unit 503 of the virtual machine 104 compares the two Web contents (the Web contents obtained from the Web server 102 and the Web contents received from the database registration information 1100) obtained in step S1203. Here, the Web contents may be directly compared with each other, or the bitmap data after the analysis of the Web contents may be compared with each other.

In step S1205, the Web contents analysis unit 503 of the virtual machine 104 performs difference determination processing for determining whether or not there is a difference between Web contents compared in step S1204. In a case where there is a difference (Yes in step S1205), the processing advances to step S1206. On the other hand, in a case where there is no difference (No in step S1205), the processing advances to step S1207.

In step S1206, the communication unit 501 of the virtual machine 104 transmits the Web image URL obtained in step S1201 to the communication apparatus 101.

In step S1207, the communication unit 501 of the virtual machine 104 transmits the URL received in step S901 and a dummy image URL insertion request to the database 106. When the database 106 receives the URL and the dummy image URL insertion request, the database 106 changes the Web image URL corresponding to the received URL to the dummy image URL in the database registration information 1100. For example, in a case where the state of the database registration information 1100 is the reference numeral 1102 and the URL received in step S901 is https://www.yahoo.co.jp, the state of the database registration information 1100 changes from the state of reference numeral 1102 to reference numeral 1103. That is, the Web image URL “xxx/yahoo.co.jp.jpeg is changed to the dummy image URL” dummy.jpeg. Note that in order to secure space in the database 106, the associated Web contents (for example, index.html in the case of the state of reference numeral 1102) may be deleted when the dummy image is inserted.

In step S1208, the Web contents analysis unit 503 of the virtual machine 104 analyzes the Web contents obtained from the Web server 102 in step S1203, and then the Web contents rendering unit 504 of the virtual machine 104 renders the Web contents. Thereafter, based on the rendered Web contents, the image generation unit 505 of the virtual machine 104 generates a Web image. The image to be generated is an image file such as a jpeg or png, for example.

In step S1209, the communication unit 501 of the virtual machine 104 uploads the image generated in step S1208 to the storage 107.

In step S1210, the communication unit 501 of the virtual machine 104 transmits the Web image URL of the upload destination uploaded in step S1209 to the communication apparatus 101.

In step S1211, the communication unit 501 of the virtual machine 104 obtains Web contents from the Web server 102. At this time, the URL requested to the Web server 102 is the URL received in step S901.

In step S1212, the communication unit 501 of the virtual machine 104 transmits the URL received in step S901, the Web image URL of the destination to which the image has been uploaded in step S907, and the Web contents obtained in step S905 to the database 106.

The communication unit 601 of the database 106 registers the information to the database registration information 1100 after reception. For example, assume the state of the database registration information 1100 is the reference numeral 1101, the information received is URL=https://www.yahoo.co.jp, and Web image URL of the upload destination=xxx/yahoo.co.jp.jpeg. Further, assume that the received Web contents are index.html. In this case, the database registration information 1101 changes to the state of the reference numeral 1102. The above described sequence of processing in FIG. 12 then ends.

As described above, according to the present embodiment, whether or not Web contents are registered in the database 106 can be determined by comparing Web contents with each other. Accordingly, it is possible to prevent a Web image that should not be registered in the database 106 from being registered.

An example of a Web image that should not be registered is an image that is generated according to Web contents that are rendered depending on the user and whose contents therefor differ. In this embodiment, unlike the second embodiment, Web contents registered in the database registration information 1100 are compared with the contents obtained from the Web server 102, rather than being determined from a specific element of the Web contents. This makes it possible to determine Web contents that should not be registered.

Further, in the present embodiment, Web contents are directly compared with each other or with the data after analyzing the Web contents. Therefore, compared to the second embodiment in which Web contents are determined from a specific element, it is possible to determine Web contents that should not be registered without being limited to a specific element. Further, as in the second embodiment, it is possible to prevent other users from obtaining and displaying a Web image, generated by a certain user, that should not be registered.

Further, in this embodiment, although an example of using a dummy image URL in a case where it is determined that there is a difference in step S1204 has been described, the present invention is not limited thereto, and other information may be used if it can be known thereby that it has been determined there is a difference in the Web contents in step S1204.

### Fourth Embodiment

In the present embodiment, the virtual machine 104 compares Web contents registered in the database 106 with Web contents obtained from the Web server 102, and performs processing for deleting the Web contents from the database 106 in a case where there is a difference.

The configuration of the system and the hardware configuration and software configuration of the communication apparatus 101 in the present embodiment are similar to those shown in FIGS. 1 to 3, respectively. Also, the hardware configuration and the software configuration of the virtual machine 104 are similar to those in FIGS. 4 and 5, respectively. Further, the hardware configuration and the software configuration of the database 106 are similar to those in FIGS. 4 and 6, respectively. Additionally, the flow of the processing performed by the communication apparatus 101 according to the present embodiment is similar to the processing of FIG. 8.

### Processing

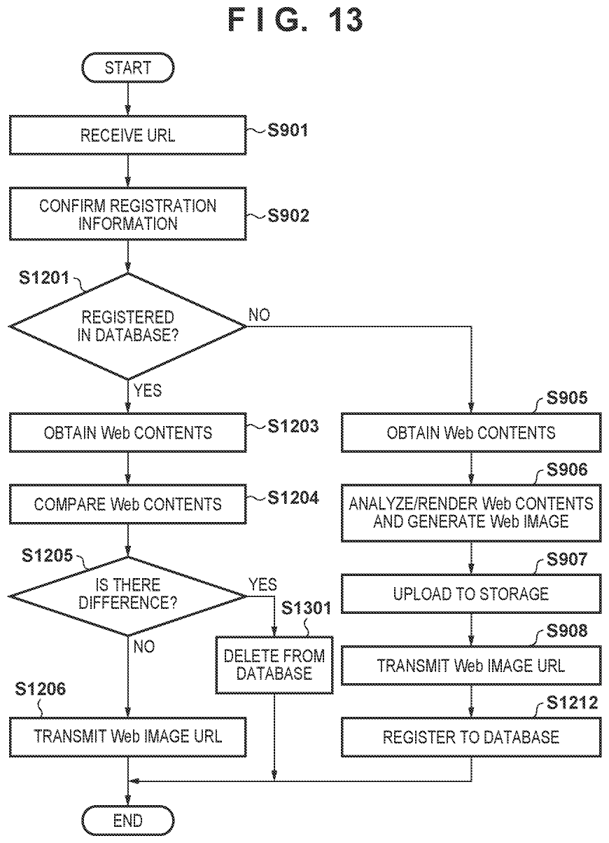

FIG. 13 is a flowchart illustrating a flow of processing performed by the image generation system 103 (mainly, the virtual machine 104 and the database 106) according to the present embodiment. The processing of this flowchart starts in a state where the user using the communication apparatus 101 activates an application for using the cloud browser and establishes a connection with the virtual machine 104. The processing of step S901, step S902, step S905 to step S908, step S1201, step S1203 to step S1206, and step S1212 of FIG. 13 is the same as the processing of the same reference numerals of FIG. 12, and therefore description will be omitted.

In step S1301, the communication unit 501 of the virtual machine 104 transmits, to the database 106, an instruction for deleting the Web contents corresponding to the URL received in step S901, which are stored in the database registration information 1100 of the database 106. The database 106 deletes the Web contents from the database 106 based on the instruction received from the virtual machine 104. The above described sequence of processing in FIG. 13 then ends.

Note that regarding the URL corresponding to the Web contents deleted once from the database 106, control may be taken such that registration is not performed in the database 106 even in a case where it is determined that the URL is not registered after the deletion. As a result, it is possible to avoid repeated registration and deletion.

As described above, in the present embodiment, in a case where there is a difference between the Web contents registered in the database 106 and the Web contents obtained from the Web server 102, the Web contents are deleted from the database 106. Thus, caching of Web contents can be avoided in a case where the content of Web contents has changed even when access by the same user is performed.

### MODIFICATION

In each of the above-described embodiments, the image generation system 103 may include a plurality of virtual machines, and each virtual machine may transmit and receive information to and from the same database 106. As a result, the effects of each of the above-described embodiments can be achieved even when a virtual machine different from the virtual machine used last time by the user is used.

Further, in each of the above-described embodiments, the virtual machine 104 need not directly transmit the Web image URL registered in the database registration information 700 or the database registration information 1100 when transmitting the Web image URL to the communication apparatus 101. For example, a signed URL may be created based on the Web image URL and then transmitted to the communication apparatus 101.

Although an example is described in each of the above-described embodiments in which the virtual machine 104 transmits the Web image URL to the communication apparatus 101, and the communication apparatus 101 obtains the image from the storage 107 using the Web image URL, the present invention is not limited to this. For example, the image generated by the image generation unit 505 of the virtual machine 104 may be saved in the virtual machine 104, and the communication apparatus 101 may obtain the image by the virtual machine 104 transmitting the image data to the communication apparatus 101.

According to the present invention, even in a case where the communication apparatus cannot analyze Web contents, the time required to display the Web contents can be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-118869, filed Jul. 26, 2022, which is hereby incorporated by reference herein in its entirety.

What is claimed is:

1. An image generation system, comprising:
a determination unit configured to determine whether or not a URL received from a communication apparatus is registered in a database; and
a transmission unit configured to transmit, in a case where it has been determined that the URL is registered, a URL of a Web image, which Web contents corresponding to the URL have been converted into, to the communication apparatus.

2. The image generation system according to claim 1, further comprising: an obtainment unit configured to obtain Web contents corresponding to the URL in a case where it has been determined that the URL has not been registered;
an analysis unit configured to analyze the Web contents; and
a generation unit configured to generate a Web image of the Web contents analyzed by the analysis unit.

3. The image generation system according to claim 2, further comprising: an upload unit configured to upload the Web image generated by the generation unit; and
a registration unit configured register the URL and a URL of the Web image uploaded by the upload unit to the database in association.

4. The image generation system according to claim 3, wherein the transmission unit transmits the URL of the Web image uploaded by the upload unit to the communication apparatus.

5. The image generation system according to claim 3, further comprising: a second determination unit configured to determine, based on the analysis result analyzed by the analysis unit, whether or not to register the URL, the URL of the Web image uploaded by the upload unit, and Web contents corresponding to the URL in association,
wherein the registration unit performs registration in a case where the determination to register is made by the second determination unit.

6. The image generation system according to claim 5, wherein the analysis result includes at least one of a cache control, cookie information, and user login information.

7. The image generation system according to claim 3, further comprising: an obtainment unit configured to obtain Web contents corresponding to the URL;
a difference determination unit configured to determine a difference between the Web contents obtained by the obtainment unit and Web contents registered in the database and corresponding to the URL; and
a deletion unit configured to delete, in a case where there is the difference, the Web contents registered in the database.

8. The image generation system according to claim 7, wherein the registration unit does not perform registration to the database for a URL corresponding to Web contents that have been deleted by the deletion unit after the deletion even in a case where it has been determined by the determination unit that the URL has not been registered.

9. The image generation system according to claim 3, further comprising: an obtainment unit configured to obtain Web contents corresponding to the URL; and
a difference determination unit configured to determine a difference between the Web contents obtained by the obtainment unit and the Web contents registered in the database and corresponding to the URL, wherein
the registration unit registers to the database identification information indicating that there is a difference between the Web contents for the URL in a case where there is a difference.

10. The image generation system according to claim 9, wherein the determination unit determines, in a case where a URL received from the communication apparatus is registered in the database, whether or not the identification information for the URL is registered, and
the obtainment unit obtains, in a case where it has been determined by the determination unit that the identification information is registered, Web contents corresponding to the URL.

11. A method for operating an image generation system that includes:
determining whether or not a URL received from a communication apparatus is registered in a database; and
transmitting, in a case where it has been determined that the URL is registered, a URL of a Web image, which Web contents corresponding to the URL have been converted into, to the communication apparatus.

12. A storage medium storing a program for causing a computer to execute a method for operating an image generation system that includes:
determining whether or not a URL received from a communication apparatus is registered in a database; and
transmitting, in a case where it has been determined that the URL is registered, a URL of a Web image, which Web contents corresponding to the URL have been converted into, to the communication apparatus.
